(19) United States
(12) Patent Application Publication
(10) Pub. No.: US 2014/0074747 A1
(43) Pub. Date: Mar. 13, 2014

(54) ASSISTANT SYSTEM FOR THE TOUR GUIDE

(71) Applicants: SHANGHAI QINLU ELECTRICAL TECHNOLOGY CO., LTD., Shanghai (CN); XI'AN HUAFAN INSTRUMENT CO., LTD., Xi'an (CN)

(72) Inventors: Shouwei Gao, Shanghai (CN); Minghua Wang, Shanghai (CN); Yue Zhao, Shanghai (CN); Qingyang Chen, Shanghai (CN); Longlong Zhao, Shanghai (CN); Jian Yuan, Shanghai (CN)

(73) Assignees: Xi'an Huafan Instrument Co., Ltd., Xi'an (CN); Shanghai QinLu Electrical Technology Co., Ltd., Shanghai (CN)

(21) Appl. No.: 13/854,496

(22) Filed: Apr. 1, 2013

(30) Foreign Application Priority Data
Sep. 11, 2012 (CN) 201210335191.8

(51) Int. Cl. G06Q 50/14; H04W 4/00

(52) U.S. Cl. CPC G06Q 50/14; H04W 4/008
USPC 705/346

(57) ABSTRACT

The invention relates to an assistant system for the tour guide, comprising a tour guide roll-call device, a plurality of labels for tourists and an intelligent mobile phone. The tourist guide roll-call device communicates with the labels tourists wearing via wireless network; the intelligent mobile phone communicates with the roll-call device via Bluetooth. After the tour guide roll-call device is respectively connected to the labels tourists wearing and the intelligent mobile phone, the intelligent mobile phone sends roll-call signal to the labels tourists wearing via the tour guide roll-call device. In setting area, the labels tourists wearing receive the roll-call signal and send feedback signal. The tour guide roll-call device receives the signal and sends it to the intelligent mobile phone. The intelligent mobile phone reads the signal to judge whether tourists are in place, and displays the roll-call result information on the screen.

### TECHNICAL FIELD

The Invention relates to a system of roll-call and telephoning, especially relates to a kind of assistant system for the tour guide.

### BACKGROUND ART

With the improvement of people's living standard, tourism has been developing vigorously. Group touring is a common method of vacationing. In such tours, a large group of people who usually don't know each other previously travel from point to point. Often, the tour guide plans a certain time at each stop, and either has to waste time tracking down missing passengers, or risk leaving them behind if the group leaves on time. For the tour guide, roll-call and looking for the absent visitors has always been a trouble. It tends to waste a lot of travel time just because the non-arrival of several visitors. In recent years, some methods have been developed to solve the above problems, for example, the Guide Assistant Device, patent for utility models, whose patent number is 201576331U and Issue Date is Sep. 8, 2010, which provides a device used to roll-call and find tourists' location. This device includes mother and child part. The process of roll-call can be completed by tour guide pressing the key on parent part and, accordingly, tourists pressing the key on child part to replay. Obviously, this process is too cumbersome. If tourists have not manually reply in time, a roll-call error will occur. What's more, this device can't give the non-arrival a call timely, which is inconvenient to use. Furthermore, this device is too independent without integrating the function of megaphone, which is often used by tour guides. As a result, tour guides have to carry megaphone separately, obviously, which is not convenient.

### DETAILED DESCRIPTION OF THE PRESENT INVENTION

The purposes of the present invention are to overcome limitations in the prior art and provide an assistant system for the tour guide, which is easy-to-carry, simple to operate, more prompt and efficient to roll-call and find the absent tourists.

The technical proposals of the present invention are as follows.

The assistant system for the tour guide includes a tour guide roll-call device, a plurality of labels for tourists to wear and an intelligent mobile phone. The tour guide roll-call device is connected to the labels tourists wearing via wireless network; the intelligent mobile phone is connected to the tour guide roll-call device via Bluetooth.

After the tour guide roll-call device is respectively connected to the labels tourists wearing and the intelligent mobile phone, the intelligent mobile phone sends a roll-call signal to the labels tourists wearing via the tour guide roll-call device. In the special area, labels tourists wearing receive the roll-call signal and send feedback signal. Then the tour guide roll-call device receives the signal and sends them to the intelligent mobile phone. According to the signal, the intelligent mobile phone judges whether tourists are in place or not, and displays the roll-call result information on the screen.

The tour guide roll-call device includes a wireless communication module, a micro-controller, a Bluetooth module, a megaphone module and a power management module. The micro-controller is respectively connected to the wireless communication module and the Bluetooth module; the power management module supplies power to the wireless communication module, the micro-controller, the Bluetooth module and the megaphone module.

The micro-controller sets initialization configuration of the Bluetooth module and the wireless communication module respectively, to transmit data freely.

The megaphone module includes a microphone amplifier circuit.

The label tourist wearing includes a wireless communication module, a micro-controller and a power management module. The power management module in the tourist terminal is connected to the wireless communication module and the micro-controller. The micro-controller is connected to the wireless communication module in the tourist terminal; the wireless communication module in the labels communicate with the wireless communication module in tour guide roll-call device via wireless network.

The intelligent mobile phone is equipped with the Bluetooth hardware, and a microprocessor module, a memory module and a display module. The microprocessor module is respectively connected to the communication module, the memory module and the display module;

The memory module stores information of all tourists. The microprocessor module compares the feedback information with all tourists' information to judge whether tourists are in place or not, and show the result on the display module.

The intelligent mobile phone equipped with the Bluetooth hardware, is supported by an application program, whose function is query the information of the tourists, dialing the number of absent tourists and displaying the result information of roll-call.

The result information of roll-call include the number of tourists, the information of absent tourists and the prompts of dial phone number of absent tourists.

The tour guide roll-call device and labels tourists wearing are all installed a function key and a bicolor LED.

Compared with the existing technology, the invention has the following advantages:

1) The invention enlarges the application range of the intelligent mobile phone by realizing the function of roll-call rapidly and telephoning the non-arrival timely, and two-way transparent transmission between the intelligent mobile phone and labels tourists wearing via the tour guide roll-call device.

2) The tour guide roll-call device in the system also has the commonly used function of megaphone. So, there's no need for tour guide to carry roll-call device and megaphone separately.

3) The supporting application program of the system can run in most mainstream intelligent mobile phone with good compatibility.

4) A tourist only needs to carry a label, which is like a name tag, small and convenient, without to do any manual operation. The appearance of the label is custom made according to different customers.

5) The application of the system can save waiting time of tourists and help tour guide roll-call rapidly and find the non-arrival quickly.

### BRIEF DESCRIPTION OF THE DRAWINGS

FIG. 1 is the structure schematic of the invention;

FIG. 2 is the structure schematic of the label tourist wearing.

### DESCRIPTION OF EMBODIMENT

The following is detail description of the invention combined with the appended drawings and concrete implementation example.

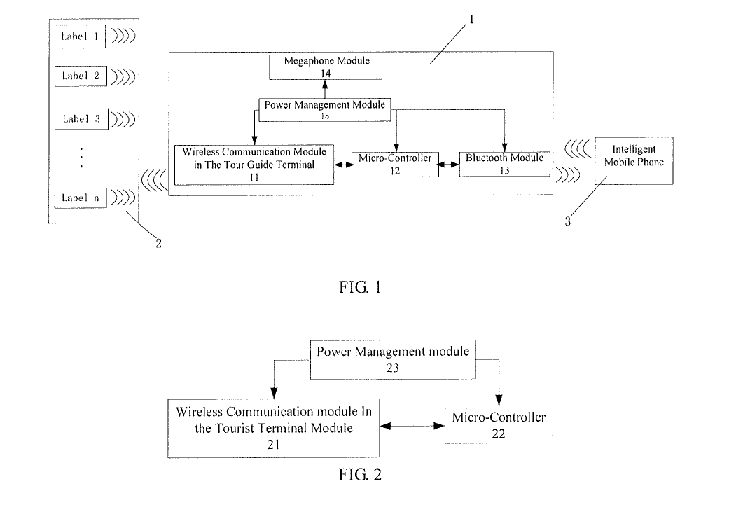

As is shown in FIG. 1, the assistant system for the tour guide includes the tour guide to roll-call device 1, the labels tourists wearing 2 and the intelligent mobile phone 3. The tour guide roll-call device 1 communicates with labels tourists wearing 2 by wireless network; the intelligent mobile phone 3 communicates with the tour guide roll-call device 1 by the Bluetooth. The number of labels can be set according to number of the tourists.

The tour guide roll-call device 1 includes the wireless communication module 11, the micro-controller 12, the Bluetooth module 13, the megaphone module 14 and the power management module 15. The micro-controller 12 is respectively connected to the wireless communication module 11 and the Bluetooth module 13; the power management module 15 is connected to the wireless communication module 11, the micro-controller 12, the Bluetooth module 13 and the megaphone module 14. The micro-controller 12 is low-power. One end of the micro-controller 12 is connected to the wireless communication module in the tour guide terminal 11, and the other end is connected to the Bluetooth module 13. The micro-controller 12 sets initialization configuration of the Bluetooth module 13 and the wireless communication module 11 respectively. Consequently, the data is transmitted freely. The Bluetooth module 13 not only can receive the data send by the micro-controller 12 and transmit it to the intelligent mobile phone wirelessly, but also can receive the wireless data from the intelligent mobile phone and send it to micro-controller 12, which is two-way communication. The wireless communication module in the tour guide terminal 11 not only can receive serial data send by the micro-controller 12 and transmit it to the labels tourists wearing wirelessly, but also can receive wireless data from labels and send it to the micro-controller 12. This is two-way communication too. Finally, two-way transparent transmission between the intelligent mobile phone and the labels tourists wearing can be realized.

As is shown in FIG. 2, the labels tourists wearing include the wireless communication module 21, the micro-controller 22 and the power management module 23. The power management module in the tourist terminal 23 is connected to the wireless communication module in the tourist terminal 21 and the micro-controller 22. The micro-controller 22 is connected to the wireless communication module 21. The wireless communication module 21 is connected to the wireless communication module 11 by low-power wireless network, which realize the function of signal automatic transceiver, and two-way transparent transmission between the intelligent mobile phone. The wireless communication module in the tourist terminal 21 is set initialization configuration by the micro-controller 22

The intelligent mobile phone equipped with Bluetooth hardware, is supported by an application program, whose function is query the information of tourists, displaying the result information of roll-call and dialing the number of absent tourists etc. The intelligent mobile phone 3 includes the Bluetooth communication module, the microprocessor module, the memory module and the display module. The memory module stores information of all tourists. The microprocessor module compares the feedback information with all tourists' information to judge whether tourists are in place, and sent roll-call result to the display module to show. The roll-call result information contains numbers of tourists, information of absent tourists and the prompts of dial phone number of absent tourists.

The power manage modules in the tour guide roll-call device 1 and the matching labels tourists wearing 2 have a USB socket, a rechargeable lithium battery, a lithium battery charging management chip and a linear stabilized voltage chip. The high-capacity rechargeable lithium battery servers as power supply of the system, and the low-dropout liner voltage regulator chip keep voltage stable. The power management module provides stable voltage for the latter stage. The lithium battery is charged through the USB socket. The lithium battery charging management chip prevents lithium batteries from over-charge or over-discharge, which damage lithium battery working life.

In the embodiment, the shell of tour guide roll-call device 1 is a cube, which physical interface adopts a Micro USB socket with charging function. The key on the device is used to change work pattern, such as Bluetooth wakeup. The device is also equipped with a bicolor LED to indicate work status. The statuses include communication status and power status. Communication status indication indicates every process of the data transmission, including normal transmission mode, configuration mode, abnormal disconnection mode, through the different light twinkle model; the power status indication refers to that red light flashing indicating insufficient electric quantity (the battery needs recharging) and the green light lighten indicating full electricity quantity.

In the embodiment, the shell of label tourist wearing 2 is cube, which physical interface adopts a Micro USB socket with charging function. There are also a key, used to change working pattern (start wireless communication, etc.), and a bicolor Led, used to indicate work status, which is similar to tour guide roll-call device.

The working principle of the system herein described is as follows. The tour guide roll-call device 1 is respectively connected to labels tourists wearing 2 and the intelligent mobile phone 3. Then the intelligent mobile phone 3 sends roll-call signal to the labels tourists wearing via the tour guide roll-call device 1. In a special area, the labels tourists wearing 2 receive the signal and send feedback information to the tour guide roll-call device 1. Then the device sends the feedback information to the intelligent mobile phone 3 to judge whether tourists are present and dial the number of non-arrival as needed. The system can help tour guide roll-call rapidly and find the non-arrival, which will save tour time. What's more, the integrated megaphone module realizes the function of the current commercially available guide-used megaphone.

1. An assistant system for the tour guide, comprising a tour guide roll-call device, a plurality of labels for tourists and an intelligent mobile phone; wherein, the tour guide roll-call device is connected to the labels tourists wearing by wireless communication; the intelligent mobile phone is connected to the tour guide roll-call device by Bluetooth communication;
after the tour guide roll-call device has respectively connected with the labels tourists wearing and the intelligent mobile phone, the intelligent mobile phone sends roll-call signal to the labels tourists wearing through the tour guide roll-call device; in the special area, the labels tourists wearing receive the roll-call signal and send feedback signal; then the tour guide roll-call device receives the signal and sends it to the intelligent mobile phone; the intelligent mobile phone judges whether tourists are in place or not, and displays the roll-call result information on the screen.

2. The assistant system for the tour guide according to claim 1, wherein the tour guide roll-call device includes a wireless communication module, a micro-controller, a Bluetooth module, a megaphone module and a power management module; the micro-controller is connected to the wireless communication part and the Bluetooth communication part respectively; the power management module supplies power for the wireless communication module, the micro-controller, the Bluetooth module and the megaphone module.

3. The assistant system for the tour guide according to claim 2, wherein in the tour guide roll-call device, the micro-controller is low-power dissipation; one end of the micro-controller is connected to the wireless communication part, and the other end is connected to the Bluetooth communication part. The micro-controller respectively sets initialization configuration of the Bluetooth communication part and the wireless communication part to transmit data normally.

4. The assistant system for the tour guide according to claim 2, wherein it is equipped with a megaphone module.

5. The assistant system for the tour guide according to claim 2, wherein the label tourists wearing include a wireless communication module, a micro-controller and a power management module; the power management module in the label supplies power to the wireless communication module and the micro-controller; the micro-controller is connected to the wireless communication module;

6. The assistant system for the tour guide according to claim 2, wherein the intelligent mobile phone is equipped with Bluetooth hardware, and a microprocessor module, a memory module and a display module; the microprocessor module is respectively connected to the communication module, the memory module and the display module.

7. The assistant system for the tour guide according to claim 6, wherein the memory module of the intelligent mobile phone stores information of all tourists; the feedback information is compared with all tourists' information to judge whether tourists are in place. The display module shows the result.

8. The assistant system for the tour guide according to claim 7, wherein the roll-call result information include number of the tourists, the battery level of the labels tourists wearing, the information of the absent tourists and the prompts of dial phone number of absent tourists.
